(19) United States
(12) Patent Application Publication
(10) Pub. No.: US 2011/0180496 A1
(43) Pub. Date: Jul. 28, 2011

(54) DEVICE FOR RETAINING A CARTON CONTAINING A DISPENSABLE ROLLED MATERIAL

(76) Inventors: Philip A. HERNBERG, Needham, MA (US); Ian Kaiser, Malibu, CA (US); Sean Neiberger, South Pasadena, CA (US)

(21) Appl. No.: 12/692,759

(22) Filed: Jan. 25, 2010

(51) Int. Cl. E05B 73/00; A47B 96/00

(52) U.S. Cl. 211/4; 211/71.01; 211/85.31; 211/78

(57) ABSTRACT

The present invention relates to a device for retaining a carton containing a dispensable rolled material. In one embodiment, the carton includes a film cutter and the rolled material is a plastic film. The device is formed of a frame including a bottom support member, side retaining member, front retaining member and rear retaining member for securely holding the front, rear, bottom and side of the carton for continuous dispensing of the rolled material until the roll of material ends. A lid lock can be coupled to the frame for holding down a lid of the carton for expeditious pulling and dispensing of the rolled material from the carton. A rotatable locking member can be rotated between an open position for receiving the carton and a closed position for retaining the carton within the frame.

### BACKGROUND OF THE INVENTION

1. Field of the Invention

The present invention relates to a device for retaining a carton and in particular to a portable device formed of a frame structure which securely holds a carton containing a dispensable rolled material in place.

2. Description of Related Art

Housings for rolled materials are known. U.S. Pat. No. 5,186,376 describes a plastic wrap dispenser used for dispensing plastic wrap from a roll. A housing may be mounted under a shelf or cupboard or on a wall. Fasteners can be attached through apertures in the housing to secure the unit to a wall. The housing includes a cover unit that is installed in place of use and a releasable base unit that fits into the bottom of the cover unit and is resiliently biased with locking tabs. The base unit carries the roll of film. The base is formed of a single molded thermoplastic unit.

U.S. Pat. No. 7,614,331 describes an organizer for dispensing rolled goods. The organizer includes first and second carousels positioned adjacent opposing ends of an axle. A plurality of connector hubs are included on the first and second carousels. Each hub receives a hollow end of a roll of the rolled goods.

It is desirable to provide a portable device for retaining a carton containing a dispensable rolled material.

### SUMMARY OF THE INVENTION

The present invention relates to a device for retaining a carton containing a dispensable rolled material. In one embodiment, the carton includes a film cutter and the rolled material is a plastic film. The device is formed of a frame including a bottom support member, side retaining member, front retaining member and rear retaining member for securely holding the front, rear, bottom and side of the carton. The device provides continuous dispensing of the rolled material until the roll of material ends, thereby reducing waste. The bottom support member can be raised above a surface supporting the device. Accordingly, the device retains the carton suspended above wet surfaces.

In one embodiment, the frame can be formed of a rubber coated metal wire for providing non-skidding of the frame on the surface supporting the device. A lid lock can be coupled to the frame for holding down a lid of the carton for expeditious pulling and dispensing of the rolled material from the carton. A rotatable locking member can be rotated between an open position for receiving the carton and a closed position for retaining the carton within the frame. In an alternate embodiment, hooks can be attached to a rear of the frame for hanging of the device on racks and/or shelves. The invention will be more fully described by reference to the following drawings.

### BRIEF DESCRIPTION OF THE DRAWINGS

FIG. 1 is a schematic diagram of a device for retaining a carton in accordance with the teachings of the present invention.

FIG. 2 is a schematic diagram of the device in which the carton is received in the device.

FIG. 3 is a schematic diagram of a lid lock of the device.

FIG. 4A is a rear view of the device including a locking arm member positioned within a hook of the device.

FIG. 4B is a front and side view of the device including the locking arm member in an open position.

FIG. 4C is a rear view of the device including the locking arm member in a closed position.

FIG. 5 is a right and top schematic diagram of the device in which a carton is received and the device is attached to a shelf.

FIG. 6 is a front and side view of the device having a received carton and including the locking arm member in an open position.

FIG. 7 is a front and side view of the device having a received carton and including the locking arm member in a closed position.

FIG. 8A is a top view of the device including a roll retaining member.

FIG. 8B is a side view of the device having a received carton and the roll retaining member retaining the carton.

FIG. 9A is a bottom plan view of the device having a received carton.

FIG. 9B is a side view of the device having a received carton.

FIG. 9C is a front view of the device having a received carton.

### DETAILED DESCRIPTION

Reference will now be made in greater detail to a preferred embodiment of the invention, an example of which is illustrated in the accompanying drawings. Wherever possible, the same reference numerals will be used throughout the drawings and the description to refer to the same or like parts.

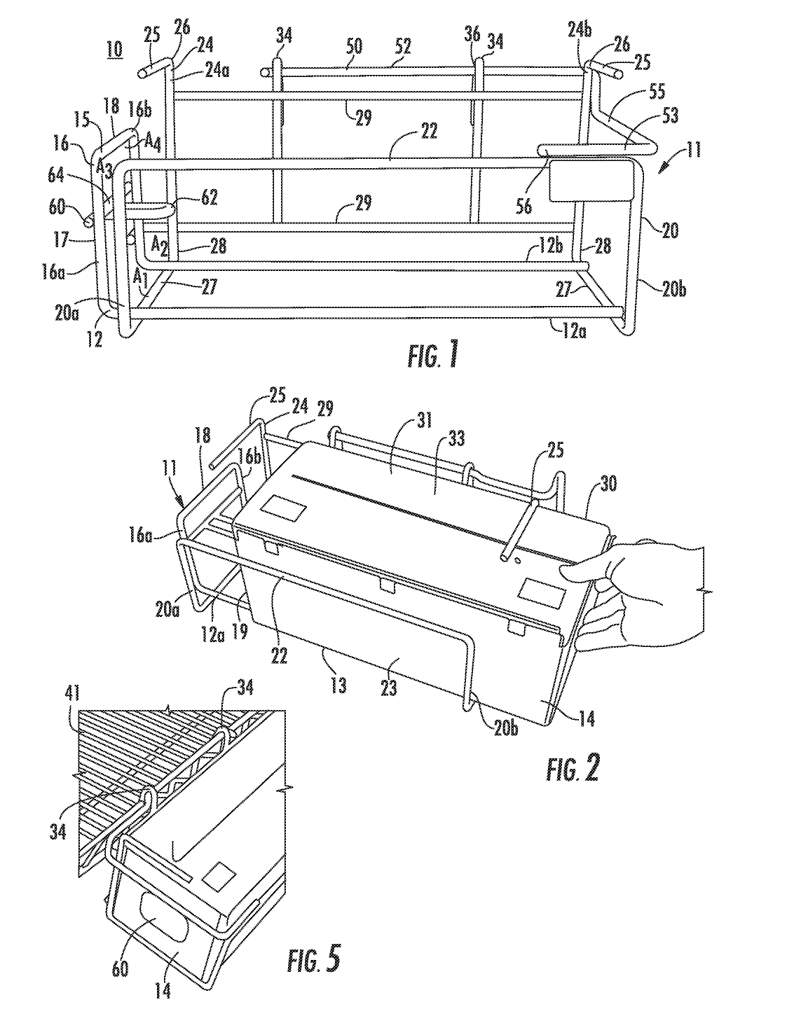

FIG. 1 is a schematic diagram of device for retaining a carton 10 in accordance with the teachings of the present invention. Frame 11 comprises bottom support member 12. Bottom support member 12 supports bottom surface 13 of carton 14 received within frame 11, as shown in FIG. 2. In this embodiment, a pair of bottom support members 12a, 12b are used, as shown in FIG. 1. Side retaining member 16 of frame 11 is positioned at side 17 of device 10. In this embodiment, side retaining members 16a, 16b extend upwardly from respective bottom support members 12a, 12b. Side retaining members 16 retain side 19 of a received carton 14 within frame 11, as shown in FIG. 2.

Referring to FIG. 1, upper side retaining member 18 can be attached to top 15 of side retaining members 16a. 16b. Side retaining members 16 can be integral with bottom support members 12 and upper side retaining member 18. In one embodiment, bottom support member 12, side retaining members 16 and upper side retaining member 18 are formed from a wire which is bent at substantially 90 degree angles A1-A4. The wire can be formed of metal. In one embodiment, the wire is formed of steel which is coated with a non-skid material. The non-skid material can be rubber.

Referring to FIG. 1 front retaining members 20 can extend upwardly from bottom support members 12. Upper front retaining member 22 can be attached to front retaining members 20. In this embodiment, a pair of retaining members 20a, 20b are used. Front retaining members 20 and upper front retaining member 22 retain front 23 of carton 14 within frame 11, as shown in FIG. 2.

Referring to FIG. 1, rear retaining members 24 extend upwardly from bottom support members 12. In this embodiment a pair of rear retaining members 24a, 24b are used. Lid lock 25 extends inwardly from top 26 of each of rear retaining members 24a, 24b. Lateral bottom support member 27 can be attached to bottom 28 of respective rear retaining member 24a, 24b and front retaining members 20a, 20b. Lateral bottom support member 27 can be positioned beneath bottom support member 12. Lateral rear retaining members 29 can be attached to rear retaining members 24a, 24b. Rear retaining members 24a, 24b, front retaining members 20a, 20b, upper front retaining member 22, lateral bottom support member and lid lock 25 can be integral to one another. In one embodiment, rear retaining members 24a, 24b, front retaining members 20a, 20b, upper front retaining member 22, lateral bottom support member and lid lock 25 are formed from a wire which is bent at substantially 90 degree angles A5-A10. Lateral rear retaining members 29 can be formed of wire. The wire can be formed of metal. In one embodiment, the wire is formed of steel which is coated with a non-skid material. The non-skid material can be rubber.

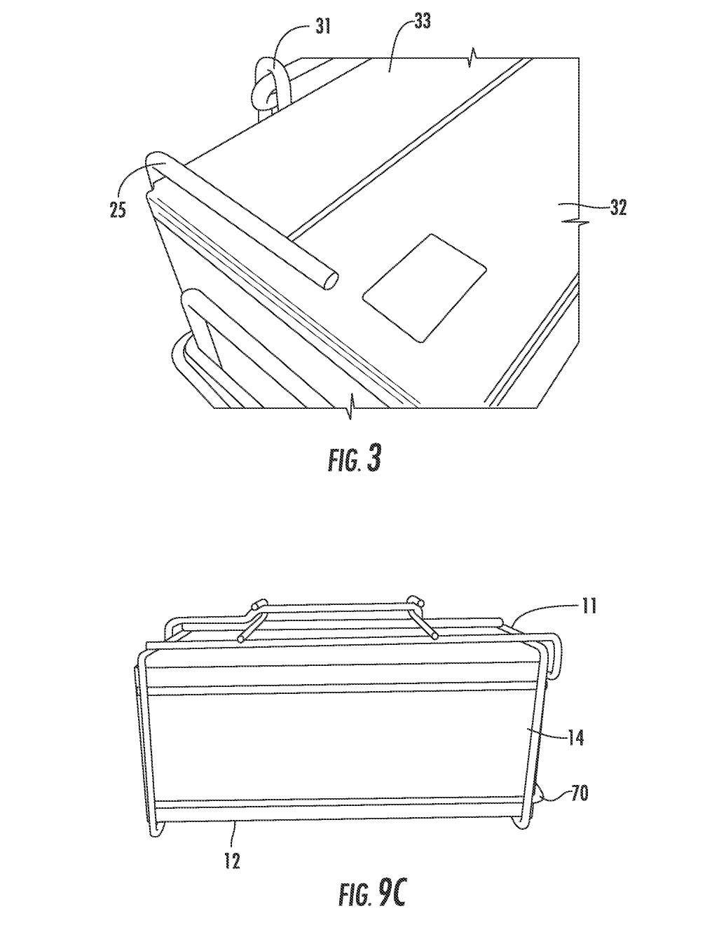

Rear retaining members 24 and lateral rear retaining members 29 retain rear 30 of carton 14 received within frame 11, as shown in FIG. 2. Lid lock 25 is positioned adjacent top 31 of carton 14 received within frame 11 for holding lid 33 down for expeditious dispensing and pulling of the dispersible rolled material 32, for example, a plastic film, from carton 14, as shown in FIG. 3.

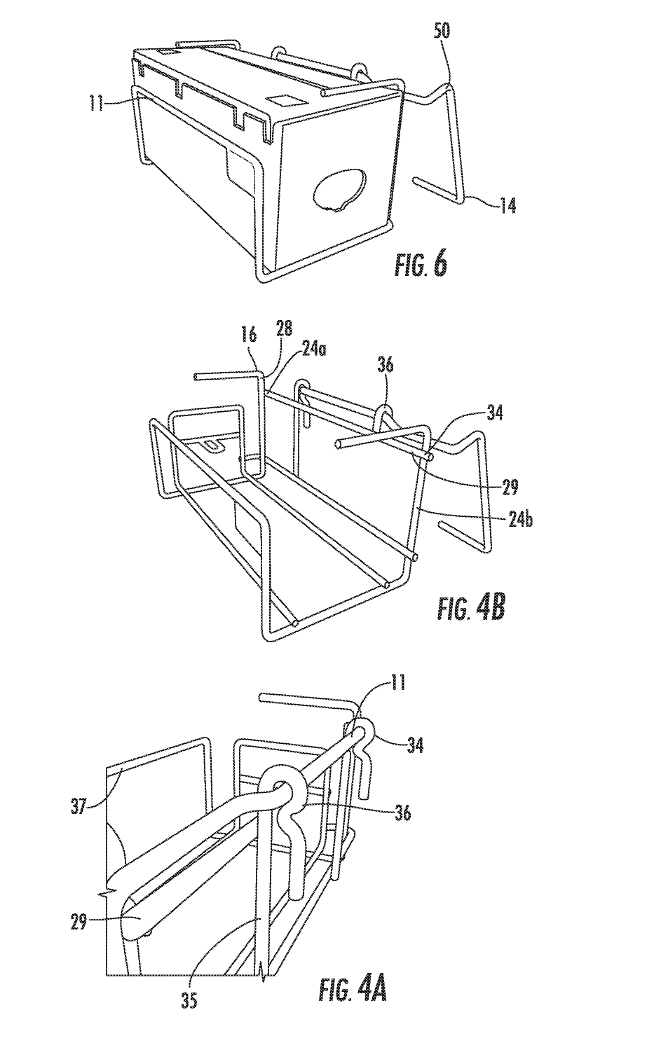

Referring, to FIGS. 4A-4C, hook member 34 extends upwardly from rear 35 of frame 11. Hook member 34 includes hook 36 at top portion 37. Hook members 34 can extend upwardly from lateral rear retaining members 29. End 38 of lateral rear retaining member 29 can be attached to side retaining member 16. Hook 36 can be received over frame 40 of wire frame shelving display 41, as shown in FIG. 5. Hook member 34 can be formed of wire. The wire can be formed of metal. In one embodiment, the wire is formed of steel which is coated with a non-skid material. The non-skid material can be rubber.

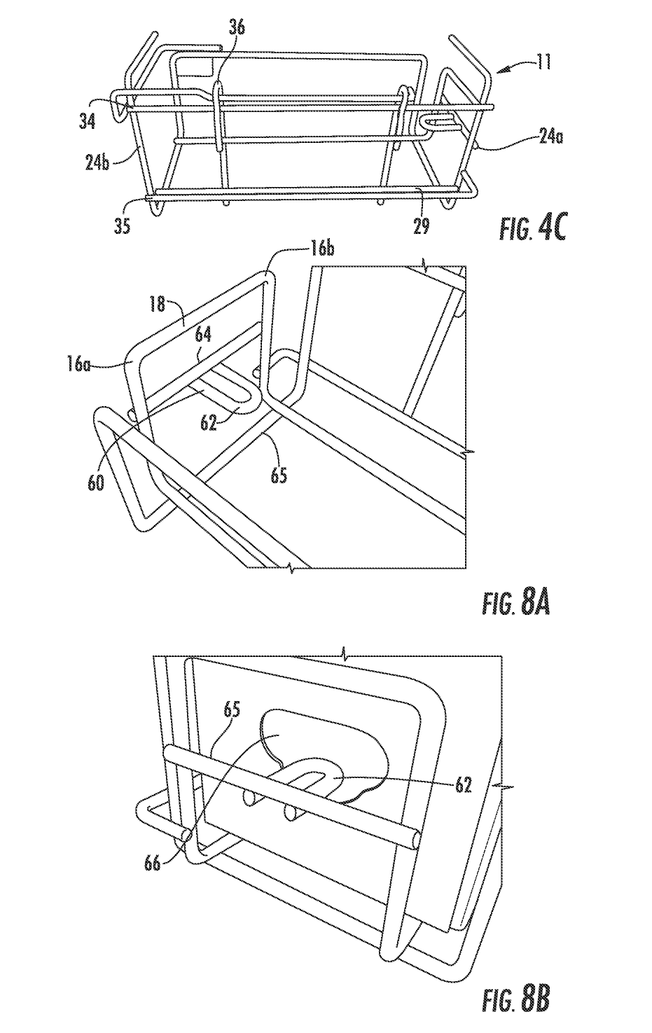

Referring to FIG. 1, rotatable locking member 50 includes support member 52. Support member 52 is positioned within hook members 34, as shown in FIG. 6. Locking arm member 53 is attached or integral with support member 52. Referring to FIG. 1, locking arm member 53 includes side locking member 55 and front locking member 56 extending inwardly from side locking member 55. Rotatable locking member 50 is rotatable from an open position shown in FIG. 6 to a closed position shown in FIG. 7. In the closed position, side locking member 55 retains side 57 of received carton 14 within frame 11 and front locking member 56 retains front 23 adjacent to side 57 of received carton 14 within frame 11, as shown in FIG. 7. Rotatable locking member 50 can be formed of wire. The wire can be formed of metal. Alternatively, rotatable locking member 50 can be formed of plastic.

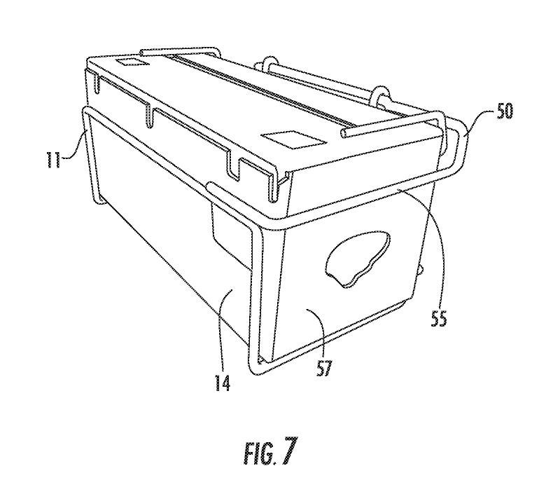

Referring to FIGS. 8A-8B, roll retaining member 60 is coupled to side retaining members 16a, 16b. Roll retaining member 60 includes protrusion 62 and support arm 64. Support arm 64 is coupled to side retaining members 16a, 16b. Protrusion 62 is coupled to support arm 64. Protrusion 62 extends from support arm 64 towards inside 65 of frame 11. Protrusion 62 can be received within opening 66 of carton 14. Protrusion 62 can extend through opening 66 into an opening within the center of a roll of dispensable material. Protrusion 62 can have a loop shape.

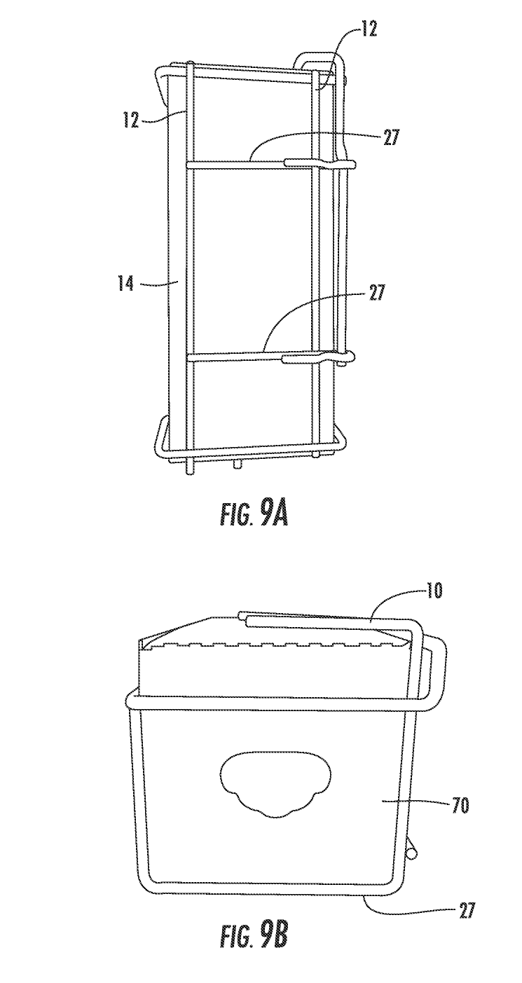

Referring to FIGS. 9A-B, lateral bottom support member 27 and bottom support member 12 raise frame 11 above surface 70 supporting device 10.

It is to be understood that the above-described embodiments are illustrative of only a few of the many possible specific embodiments, which can represent applications of the principles of the invention. Numerous and varied other arrangements can be readily devised in accordance with these principles by those skilled in the art without departing from the spirit and scope of the invention.

What is claimed is:

1. A device for retaining a carton comprising:
a frame, the frame comprises a bottom support member, side retaining member, front retaining member and rear retaining member adapted for retaining a carton received in the frame.

2. The device of claim 1 wherein the bottom support member supports a bottom surface of the carton adapted to be received within the frame above a surface supporting the frame.

3. The device of claim 1 wherein the bottom support member comprises:
a pair of the bottom support members and the side retaining member comprises a pair of side retaining members extending upwardly from a respective one of the pair of bottom support members.

4. The device of claim 3 further comprising an upper side retaining member attached to a top end of each of the side retaining members.

5. The device of claim 4 wherein the pair of side retaining members can be integral with the pair of bottom support members and the upper side retaining member.

6. The device of claim 5 wherein the pair of bottom support members, the pair of side retaining members and the upper side retaining member are formed from a wire which is bent at substantially 90 degree angles between the pair of bottom support members and the pair of side retaining members and between the pair of side retaining members and the upper side retaining member.

7. The device of claim 1 wherein the frame is formed of a metal wire.

8. The device of claim 7 wherein the metal wire is a steel wire.

9. The device of claim 7 wherein the metal wire is coated with a non-skid material.

10. The device of claim 9 wherein the metal wire is coated with rubber.

11. The device of claim 1 wherein the front retaining member comprises:
a pair of the front retaining members extending upwardly from the bottom support member and an upper front retaining member attached between the pair of front retaining members.

12. The device of claim 11 wherein the rear retaining member comprises:
a pair of rear retaining members extending upwardly from the bottom support member.

13. The device of claim 12 further comprising:
a lid lock extending inwardly from a top of the rear retaining members.

14. The device of claim 13 further comprising a lateral bottom support member coupled to a bottom of the pair of rear retaining member and a bottom of the pair of front retaining members, the lateral bottom support being positioned beneath the bottom support member.

15. The device of claim 14 further comprising a lateral rear retaining member coupled to each of the rear retaining members in the pair of rear retaining members.

16. The device of claim 15 wherein the pair of rear retaining members, the pair of front retaining members, the upper front retaining member, the lateral bottom support member and the lid lock are integral to one another.

17. The device of claim 1 further comprising:
a hook member extending upwardly from a rear of the frame.

18. The device of claim 17 further comprising:
a rotatable locking member, the rotatable locking member including a support member and a locking arm member, the locking arm member is attached or integral with the support member, the support member being positioned within the hook member and the rotatable locking member is rotatable from an open position to a closed position.

19. The device of claim 18 wherein the locking arm member comprises:
a side locking member and front locking member, the front locking member extending inwardly from the side locking member, in the closed position the front locking member being adapted to retain a front of a received carton which is opposite to the front retaining member within the frame and the side locking member being adapted to retain a side of received a carton which is opposite to the side retaining member within the frame.

20. The device of claim 1 further comprising:
a roll retaining member coupled to the side retaining member, the roll retaining member comprising a protrusion.

21. The device of claim 20 wherein the roll retaining member further comprises:
a support arm, the support arm being coupled to the side retaining member, the protrusion extending from the support arm towards an inside of the frame.
